(19) United States
(12) Patent Application Publication
(10) Pub. No.: US 2025/0045930 A1
(43) Pub. Date: Feb. 6, 2025

(54) UNSUPERVISED ZERO-SHOT SEGMENTATION MASK GENERATION AND SEMANTIC LABELING

(71) Applicant: Google LLC, Mountain View, CA (US)

(72) Inventors: Mar Gonzalez Franco, Seattle, WA (US); Junjiao Tian, Atlanta, GA (US); Lavisha Aggarwal, Bellevue, WA (US); Andrea Colaco, Los Altos, CA (US)

(21) Appl. No.: 18/792,206

(22) Filed: Aug. 1, 2024

Related U.S. Application Data
(60) Provisional application No. 63/517,019, filed on Aug. 1, 2023.
(60) Provisional application No. 63/581,538, filed on Sep. 8, 2023.

(51) Int. Cl. G06T 7/12; G06T 3/40; G06V 10/25

(52) U.S. Cl. CPC G06T 7/12; G06T 3/40; G06V 10/25

(57) ABSTRACT

Implementations relate to generation of segmentation masks for images in a zero-shot, unsupervised manner. Implementations also relate to generation of labels for the segmentation layers of the segmentation mask. Implementations use self-attention maps from a pass of the image through a generative image model to determine the segmentation mask and may use cross-attention maps generated when a prompt describing the image is provided with the image to the generative image model. Implementations aggregate maps from different resolutions to determine the mask and labels. The disclosed techniques enable accurate segmentation for any image without apriori training, facilitating applications in image processing, computer vision, extended reality applications, and robotics.

### CROSS-REFERENCE TO RELATED APPLICATIONS

This application is a non-provisional of, and claims priority to, U.S. Provisional Application No. 63/517,019, filed on Aug. 1, 2023, entitled “Unsupervised Zero-Shot Segmentation Using A Stable Diffusion Model,” and U.S. Provisional Application No. 63/581,538, filed on Sep. 8, 2023, entitled “Adding Semantic Labels To A Segmentation Mask Using A Stable Diffusion Model,” the disclosures of which are incorporated by reference herein in their entirety.

### BACKGROUND

Producing quality semantic segmentation masks for images is a fundamental problem in computer vision. Semantic segmentation is important for image editing, robotics, medical imaging, autonomous driving, and other downstream tasks. Current methods of segmentation include large-scale supervised training to enable zero-shot segmentation, but supervised training is expensive and does not scale. Current methods also include unsupervised training to enable segmentation without dense annotations, but such methods do not enable zero-shot segmentation.

### SUMMARY

Disclosed implementations provide techniques for using a generative image model to segment anything in an unsupervised and zero-shot manner. The generative image model may be a stable diffusion model. Implementations take an image (a generated image, a real-word image, an augmented or extended reality image, etc.) and generate a segmentation mask for the image using attention layers of the generative image model. An attention layer can be a self-attention layer that reflects relationships (as probabilities) between portions of the image at a particular resolution. The generative image model produces several self-attention layers at different resolutions, so that the portions represent different sized regions of the image. Implementations may first aggregate the probabilities (also referred to as self-attention maps) represented in the different layers into a highest resolution. The aggregation may produce a series of aggregated attention maps in the highest resolution. Implementations may then iteratively merge the series of aggregated attention maps to object proposals. Merging may be done using evenly spaced anchor points, where each anchor point is assumed to be an object. Implementations may merge aggregated attention maps if they are sufficiently similar (e.g., KL divergence smaller than a threshold). Merging two aggregated attention maps indicates the two maps are part of the same object layer in the segmentation mask. The result of iteratively merging the series of aggregated attention maps is generation of two or more object layers, or segmentation layers, for the image. Each portion of the image is assigned to one of the segmentation layers. A segmentation mask is the combination of the segmentation layers.

In some disclosed implementations, labels may be assigned to the segmentation layers. The labels may be from tokens (words) describing the input image. A description of the image may be generated by a language model, such as a captioning model. A description may be a prompt used to generate the image. Such implementations may use cross-attention layers of the generative image model, which reflect relationships between the words (tokens) in the description and portions of the input image. Implementations may use the cross-attention layers to assign each layer of the segment mask a word from the description. In particular, cross-attention layers may be aggregated and used to determine which segment layer(s) have the highest association with which words. Thus, in some disclosed implementations, cross-attention layers can be used to generate label assignments for the segmentation layers of the segmentation mask.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example system for generating a zero-shot segmentation mask and label assignment, according to disclosed implementations.

FIG. 1B illustrates additional details of the system of FIG. 1A, according to disclosed implementations.

FIG. 1C illustrates an example of a generative model architecture, according to disclosed implementations.

FIG. 2A illustrates a visualization of two self-attention tensors of a generative image model that are used to generate a segmentation mask, according to disclosed implementations.

FIG. 2B illustrates a visualization to two example cross-attention maps that are used to assign labels to a segmentation mask, according to disclosed implementations.

FIG. 3 illustrates a visualization of self-attention aggregation, according to disclosed implementations.

FIG. 4 illustrates an example of an iterative self-attention merging process, according to disclosed implementations.

FIG. 5 illustrates an example method for generating a segmentation map, according to disclosed implementations.

FIG. 6 illustrates an example method for generating a label assignment, according to disclosed implementations.

FIGS. 7A and 7B illustrate evaluations of disclosed implementations against existing systems.

FIG. 8 illustrates resulting segmentation maps that result from using self-attention maps of different resolutions while keeping other parameters constant.

FIGS. 9A and 9B illustrate graphs showing the effects of differing values of parameters, according to some implementations.

FIGS. 10A and 10B illustrate examples of segmentation masks generated using disclosed techniques.

### DETAILED DESCRIPTION

Disclosed implementations provide an unsupervised, zero-shot semantic segmentation of an input image. Zero-shot segmentation is desirable because it avoids the costs of labeling, which can be quite high and can limit scalability and usefulness. However, constructing a model capable of segmenting anything (not just background and foreground) in a zero-shot manner without any annotations is a technical problem not addressed by current methods. Moreover, identifying a segment as associated with a particular token is an extremely difficult problem for machines, especially where the segmentation model is capable of segmenting anything.

Semantic segmentation divides an image into regions of entities sharing the same semantics. It is an important foundational application for many downstream tasks such as image editing, medical imaging robotics, AR/VR/XR applications, autonomous driving, etc. Existing systems use supervised semantic segmentation, where a target dataset is available and the categories are known, but these systems can require billions of segmentation annotations, the high cost of which prohibits widespread application. Disclosed implementations provide unsupervised and zero-shot segmentation methods, applicable for any images with unknown categories, solving a challenging technical problem of successfully generating a segmentation mask with no form of annotations and no prior knowledge of the target.

Unsupervised and zero-shot segmentation methods are technically challenging because of the combined difficulty of the unsupervised and the zero-shot requirements. To address these issues, disclosed implementations utilize the power of a stable diffusion model to construct a general segmentation model. In particular, implementations utilize the unconditioned self-attention layers in a stable diffusion (SD) model. These self-attention layers contain specific spatial relationships between portions of an input image, namely intra-attention similarity and inter-attention similarity. Implementations uncover segmentation masks for any objects in an image by disentangling the unconditioned visual information.

Disclosed implementations offer a technical solution to generating a segmentation mask by constructing an engine, e.g., a segmentation engine, capable of segmenting anything in a zero-shot manner using attention layers of a generative image model, such as a stable diffusion model. Implementations utilize the discovery that object grouping is an emergent property in the self-attention layers of a generative image model, such as a stable diffusion model. Put another way, the segmentation engine uses a generative image model, such as a pre-trained stable diffusion model, which has learned inherent concepts of objects within its attention layers. Implementations introduce an iterative merging process based on measuring KL (Kullback-Leibler) divergence among attention maps generated by the generative image model operating on an input image to merge the attention maps into valid segmentation masks. The disclosed methods and systems do not require any training or language dependency to extract quality segmentation for any input images. In summary, implementations use a pre-trained stable diffusion model and can segment images in the wild without any prior knowledge or additional resources. Implementations can produce fine-grained segmentation for synthetic images generated from its stable diffusion backbone, which in turn can be used to generate new segmentation datasets for use in other models.

Disclosed implementations also provide a technical solution for providing semantic labels for segments in the segmentation mask. Implementations may include a diffusion semantic engine that uses the self-attention and cross-attention layers of the generative image model, such as a stable diffusion model, to assign segmentation layers to a semantic category. The semantic category represents a word from a prompt provided with the input image. The prompt can be used to generate the image, or the prompt can describe the image. The prompt can be generated by a caption model. Implementations aggregate cross-attention information from the stable diffusion model to identify a word from the prompt with highest relation to each segment layer of the segment mask. Layers corresponding to the same word can be combined. Regions of the image can thus have a label assignment. Such label assignment is also done in an unsupervised, zero-shot manner.

Because disclosed methods and systems do not require training or language dependency, implementations can be used for any computer vision problem (including for image editing, robotics, medical imaging, autonomous driving, AR/VR applications, etc.) where the computing device needs understanding of what is in front of it, e.g., when the computing device needs to understand a scene. Segmentation helps the computing device understand the scene and enables the computing device to pinpoint different regions of the scene that correspond to different objects. The region that corresponds to a particular object can then be the object of further, more focused, processing. While segmentation does not indicate what an object is, a segmentation mask can be used by other processes. Put another way, an accurate segmentation mask enables another process to focus on the portion of the image represented by a segmentation layer for further processing, rather than having to deal with an entire complex image. For example, a segmentation mask can be provided to a classifier, which provides a prediction of what object is represented in the portion of the image corresponding to a segmentation layer of the segmentation mask. This focusing can make the further processing more efficient (faster) and more accurate. As demonstrated herein, implementations can include objects in the same segment (segment layer) even if the objects are not touching in the image. Other models/processes can then be used to determine what the objects are. In some examples, the other models could be used to develop training labels for other machine-learning tasks.

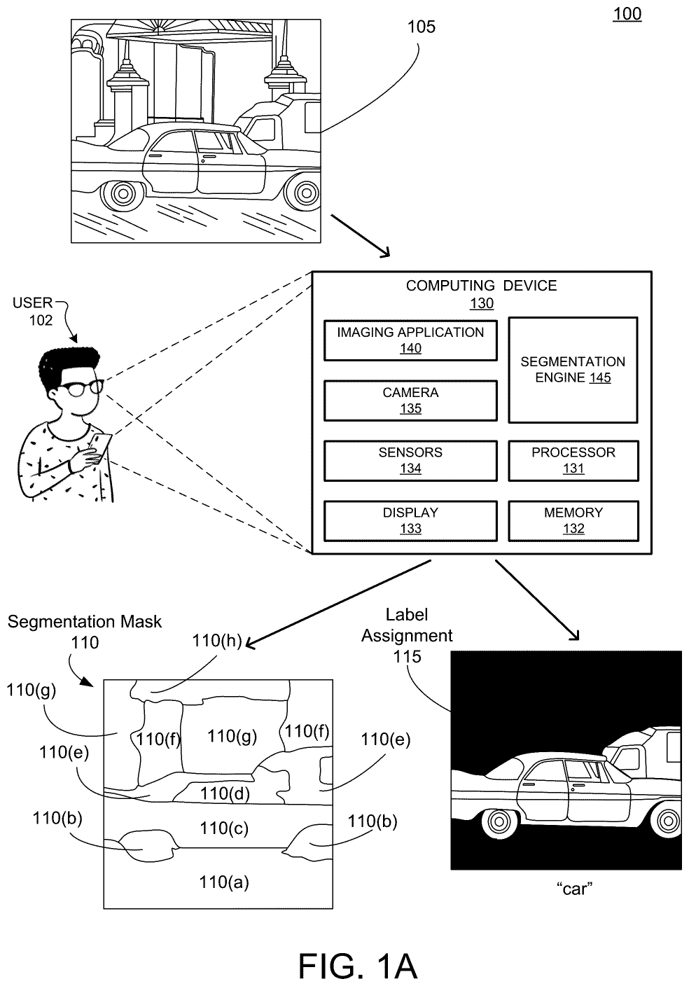

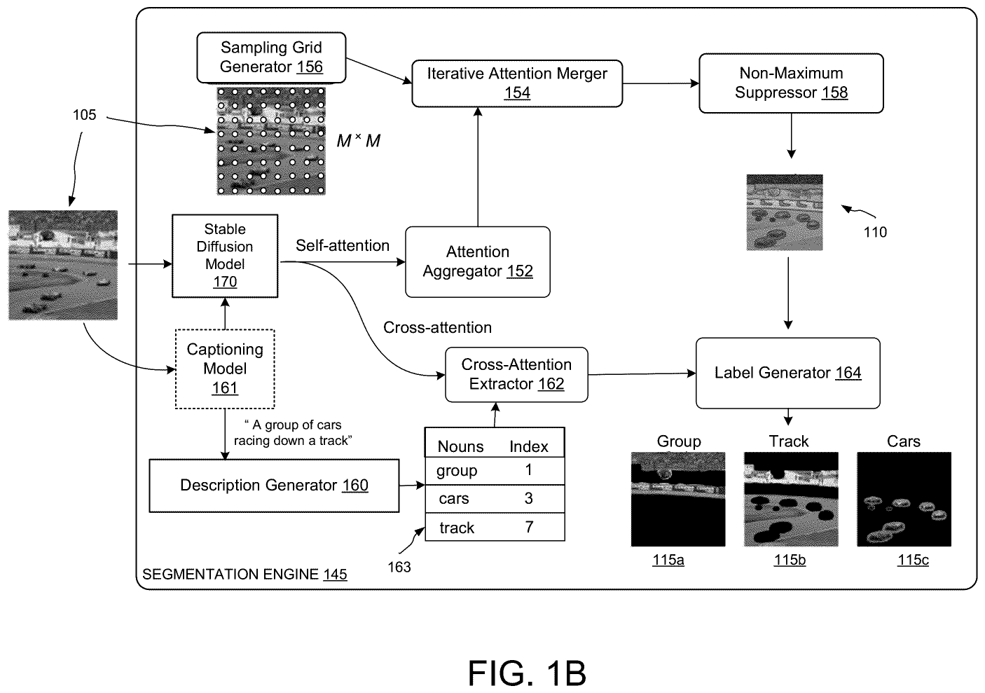

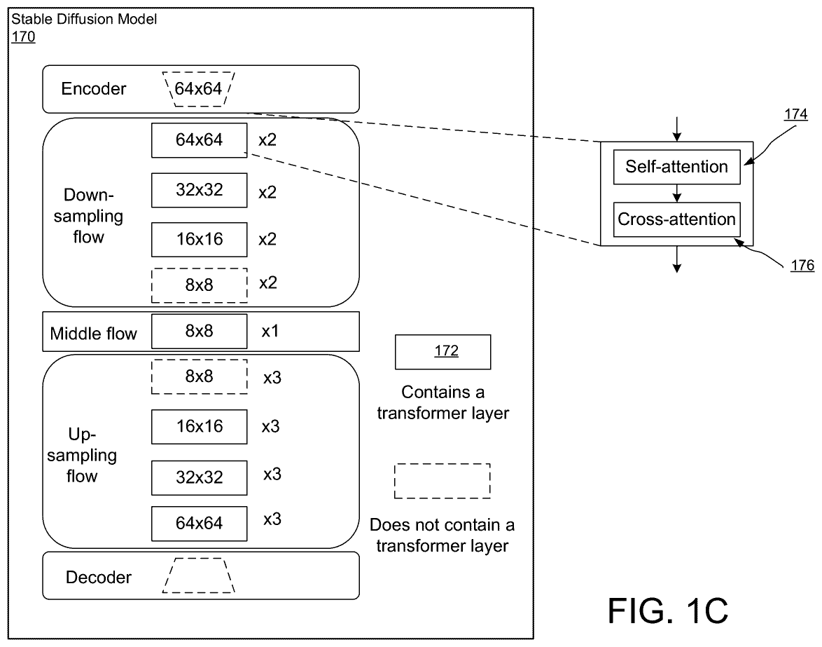

FIG. 1A illustrates an example system 100 for generating a zero-shot segmentation mask and label assignment, according to disclosed implementations. The system 100 is configured to take an input image 105 and compute a segmentation mask 110 for the input image 105. In some implementations, a label assignment 115 may also be generated for at least some layers of the segmentation mask 110. The label assignment 115 thus associates a region or regions of the image 105 with a word or words. In the example of FIG. 1A the label “car” is associated with the non-black portion of the image 105. In the example of FIG. 1A, the label “car” is associated with layers 110(b), 110(c), 110(d), and 110(e) of the segmentation mask 110.

System 100 includes computing device 130 used by a user 102. The computing device 130 is illustrated as either a smart phone or smart glasses, but the computing device 130 of disclosed implementations is not so limited. The computing device 130 can be included in a robot or a car, can be a tablet, a virtual reality or extended reality headset, a server, a desktop, a laptop, or any other computing device used in an imaging setting. The computing device 130 can include, among other components, a display 133, sensors 134, camera 135, imaging application 140, and segmentation engine 145. The imaging application 140 and segmentation engine 145 may be stored as instructions in a memory, such as memory 132. In some implementations, the segmentation engine 145 may be a component of the imaging application 140. In some implementations, the segmentation engine 145 may be called by or in communication with the imaging application 140. The imaging application 140 can be any application that uses scene understanding in the form of a segmentation mask. The imaging application 140 may use the camera 135 to obtain the input image 105. The imaging application 140 may use a model (not shown) to generate the input image 105. The computing device 130 may provide the input image 105. Some or part of the input image 105 can be generated. For example, in an AR/XR environment, computer-generated graphics may be combined with a real-world image from the camera 135. The input image 105 can be any combination of a real-world image captured using the camera 135 and computer-generated content. In some implementations, camera 135 may be used to provide environment mapping, provide spatial tracking, and enable augmented reality experiences for user 102. Sensors 134 may include accelerometers and gyroscopes for tracking movement, microphones for capturing voice commands or other audio, depth sensors for spatial awareness and environment mapping, or some other type of sensor.

The computing device 130 may include several hardware components including a communication module (not shown), memory 132, a processor 131, such as a central processing unit (CPU) and/or a graphics processing unit (GPU), one or more input devices, (e.g., touch screen, mouse, stylus, microphone, keyboard, etc.), and one or more output devices (e.g., display 133, speaker, vibrator, light emitter, etc.). The hardware components can be used to facilitate operation of applications, including imaging application 140 and/or segmentation engine 145, an operating system (O/S) and/or so forth of the computing device 130. The memory 132 can be used for storing information associated with applications, such as imaging application 140 and/or segmentation engine 145. The processor 131 can be used for processing information and/or images associated with the applications.

FIG. 1B illustrates additional details of the segmentation engine 145 system of FIG. 1A, according to disclosed implementations. The segmentation engine 145 provides a simple yet effective post-processing method for producing segmentation masks by using the self-attention maps generated by the self-attention layers in a diffusion model 170. In some implementations, the segmentation engine 145 may also provide label assignments 115 (e.g., 115a, 115b, 115c) to portions of the input image 105.

A stable diffusion model is a popular variant of the diffusion model family, which is a type of generative model, used for computer vision applications. Put another way, a stable diffusion model is a type of generative image model. A stable diffusion model learns a forward and reverse diffusion process to generate an image from a sampled isotropic Gaussian noise image. More specifically, diffusion models have a forward and reverse pass. In the forward pass, at every time step, a small amount of Gaussian noise is iteratively added until an image becomes an isotropic Gaussian noise image. In the reverse pass, the diffusion model is trained to iteratively remove the Gaussian noise to recover the original clean image. Earlier diffusion models conduct the diffusion process in the original high-dimensional image space, which is slow to train and causes instability.

A stable diffusion model, such as diffusion model 170, introduces an encoder-decoder and U-Net design with attention layers to address the instability issue, and may optionally add conditions for image generation, such as text prompt. A stable diffusion model consists of an encoder-decoder module and a latent space diffusion U-Net. FIG. 1C illustrates an example of a stable diffusion model architecture, according to disclosed implementations. An image is first compressed by the encoder to a smaller latent space and is fed to the diffusion U-Net to go through the diffusion process, and is finally decompressed to the original image space by the decoder. The U-Net is a stack of modular blocks consisting of ResNet modules and Transformer modules, also referred to as transformer layers 172. A stable diffusion model first compresses an image x∈ [symbol] ^{H×W×3} into a hidden space with smaller spatial dimension z∈ [symbol] ^{h×w×c} using an encoder z=ε(x), which can be decompressed through a decoder \tilde{x}= [symbol] (z). All diffusion processes happen in the compressed latent space through a U-Net architecture.

The U-Net architecture consists of a stack of modular blocks. 16 of them have two major components: a ResNet layer and a Transformer layer 172. The Transformer layer 172 uses two types of attention mechanisms, self-attention, and cross-attention. Put another way, and as illustrated in FIG. 1C, transformer layer 172 includes a self-attention layer 174 and a cross-attention layer 176. Self-attention is used to learn the global attention across the image. Cross-attention is used to learn attention between the image and optional text input. The self-attention layer 174 in the Transformer layers 172 is a component of interest for generating a segmentation mask. Specifically, there are a total of 16 self-attention layers 174 distributed in the 16 composite blocks of the U-Net architecture, giving 16 self-attention tensors:

$$∈ \{ {k}_{} ∈ {{h}_{k} / {w}_{k} \times {h}_{\text{?}} \times {w}_{\text{?}}}^{} \vert k = 1 , … , 16 \} . \qquad ( 1 )$$

$$\text{?} \text{indicates text missing or illegible when filed}$$

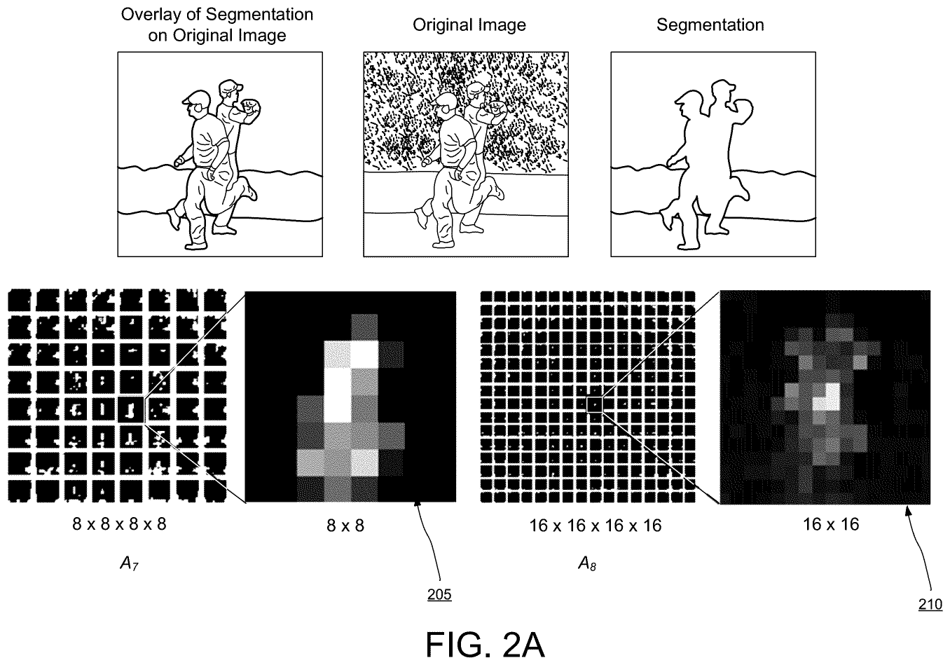

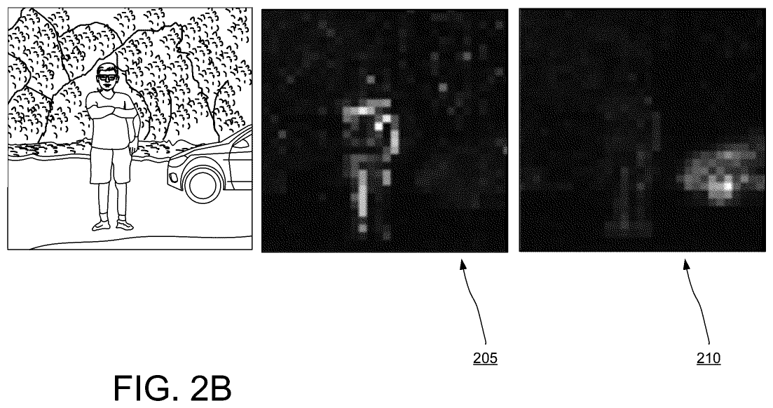

A tensor is a data structure holding integers, floating-point, or string values. A tensor is n-dimensional and in the diffusion model 170, each self-attention tensor Aₖ is a 4-dimensional tensor¹ that captures pixel-to-pixel self-attention in an image. This pixel-to-pixel self-attention is captured by grouping pixels into portions and, for each portion, scoring the relevance of the portion to every other portion of the image. The relevance score is a measure of the probability of two portions belonging to the same object in the image. This relevance scoring for a portion is referred to as a self-attention map for the portion. The self-attention maps can also be referred to as (described) as reflecting relationships between portions of the image. An attention tensor is thus a series, i.e., a plurality of, attention maps; each attention map being a two-dimensional data structure. The two dimensions of the self-attention map are referred to as the last two dimensions of the self-attention tensor. The first two dimensions of the self-attention tensor represent the dimensions of the data structure that holds the self-attention maps. FIG. 2A illustrates an example visualization of two 4D self-attention tensors, A₇ and A₈, having two different dimensions. ¹ There is a fifth dimension due to a multi-head attention mechanism. Every attention layer has 8 multi-head outputs. Implementations average the self-attention maps along the multi-head axis to reduce to 4 dimensions.

The cross-attention layer 176 in the Transformer layers 172 is a component of interest for generating label assignments for the segmentation mask. In some implementations there are a total 16 cross-attention layers 176 distributed in the 16 composite blocks of the U-Net architecture, resulting in 16 cross-attention tensors A_{c}. The cross-attention tensors can be represented as:

$${C}_{} ∈ \{ {c}_{} ∈ {{h}_{c} \times {w}_{c} \times Q}^{} \vert c = 1 , … , 16 \} .$$

where Q represents the number of tokenized words in the prompt. In some stable diffusion models, Q=77. However, unlike the self-attention tensors Aₖ, the cross-attention tensor is a 3-dimensional tensor, where each A_{c}[:, :, q]∈ [symbol] ^{(h}^{_{c}}^{×w}^{_{c}}⁾, ∀_{q}∈{1, . . . , Q} is the un-normalized cross-attention map with respect to token q. FIG. 2B illustrates a visualization of example cross-attention maps, according to disclosed implementations. In the example of FIG. 2B, the cross-attention map 220 is associated with the token “person” and the cross-attention map 225 is associated with the token “vehicle”. The example prompt may be “person, vehicle” or “a person and a vehicle.”

The segmentation engine 145 operates based on the self-attention tensors containing inherent object grouping information and that can be used to produce segmentation masks. Specifically, for each spatial location (I, J) in the self-attention tensor Aₖ, the corresponding 2D self-attention map Aₖ[I, J, :, :]∈ [symbol] ^{(h}^{ₖ}^{×w}^{ₖ}⁾ captures the semantic correlation between all locations and the location (I, J). Additionally, ΣAₖ[I, J, :, :]=1 is a valid probability distribution. As indicated above, FIG. 2A illustrates a visualization of two self-attention tensors, specifically, self-attention tensors A₇ and A₈ are visualized. The dimensions are A₇∈ [symbol] ⁸^{⁴} and A₈∈ [symbol] ¹⁶^{⁴} respectively, where [symbol] ¹⁶^{⁴} denotes [symbol] ^{16×16×16×16}. FIG. 2A illustrates a magnified 2D self-attention map 205 corresponding to location (4,4) in the self-attention tensor A₇ and a magnified self-attention map 210 corresponding to location (8,8) in A₈. As illustrated, the self-attention map for location (4,4) is a probability distribution showing the likelihood that the region of the image corresponding to (4.4) is part of the same kind of object as the other regions represented by the other locations. In the example of FIG. 2A, brighter areas indicate higher values, i.e., higher probability. Thus, a self-attention tensor is a data structure that reflects relationships between portions of the image. As illustrated in FIG. 2A, these self-attention tensors can be at different resolutions; for example, each region of the self-attention map 205 represents more pixels in the original input image than each region of the self-attention map 210.

More specifically, self-attention maps from a stable diffusion model have two properties: Intra-Attention Similarity and Inter-Attention Similarity. Maps of different resolutions have varying receptive fields with respect to the original image. In Intra-Attention Similarity, within a 2D self-attention map, each location has a strong response with its surrounding locations if the corresponding pixel location in the original image space belongs to the same object, e.g. Aₖ[I, J, I+1, J+1] is likely to be a large value. Inter-Attention Similarity, between two 2D self-attention maps, neighboring self-attention maps share similar activations if they belong to the same object in the original image space, e.g., Aₖ=[I, J, :, :] and Aₖ[I+1, J+1, :, :] are likely to be similar if (I, J) and (I+1, J+1) belong to the same object.

Additionally, the resolution of the self-attention map dictates the size of its receptive field with respect to the original image. A smaller resolution corresponds to a larger respective field. In other words, lower resolution maps, e.g., 8×8 provide a better grouping of large objects as a whole and larger resolution maps e.g., 16×16 provide a more fine-grained grouping of components in larger objects and potentially are better for identifying small objects. Overall, the current stable diffusion model has self-attention maps in 4 resolutions (hᵢ, wᵢ)∈{8×8, 16×16, 32×32, 64×64}. Implementations build on these observations to include a heuristic to enable the attention aggregation to aggregate weights from different resolutions and an iterative method to merge all self-attention maps into a valid segmentation.

Because the self-attention layers capture inherent object grouping information in the form of spatial attention (probability) maps, implementations use a post-processing method to aggregate and merge attention tensors into a valid segmentation mask. FIG. 1B illustrates an example pipeline for the segmentation engine 145, which includes three components: an attention aggregator 152, an attention merger 154, and a non-maximum suppressor 158. In particular, the segmentation engine 145 takes advantage of a property of the self-attention layer in the Transformer module of a U-Net of a stable diffusion model, which enables the segmentation engine 145 to operate without adding a new network or additional training on a new target dataset and without synthesizing and querying multiple images and, more importantly, without even knowing the objects in the image, thus removing the need for text input.

Example stable diffusion models 170 are prompt-conditioned and normally run for ≥50 diffusion steps to generate new images. However, because implementations aim to efficiently extract attention maps for an existing clean image without conditional prompts, implementations may use only the unconditioned latent and may run the diffusion process once. The unconditional latent may be calculated using an unconditioned text embedding. Because implementations may only do one pass through the diffusion model, implementations may set the time-step variable t (used by the diffusion model 170) to a large value, e.g., t=300.

Returning to FIG. 1B, the segmentation engine 145 includes three main components: attention aggregator 152, iterative attention merger 154, and non-maximum suppressor 158. Attention aggregator 152 is configured to aggregate the 4D self-attention maps generated by the diffusion model 170 processing the input image 105. The attention aggregator 152 aggregates the 4D self-attention maps in a spatially consistent manner to preserve visual information across multiple resolutions. The attention aggregator 152 outputs an aggregated attention tensor, also referred to as a series or plurality of aggregated attention maps. Each aggregated attention map corresponds to a region of the input image 105. The aggregated attention maps represent probability distributions for the input image 105. Each aggregated attention map is a valid probability distribution indicating how similar the region (portion) represented by the aggregated attention map is to other regions (portions) of the input image 105.

More specifically, in a single denoising pass through the U-Net, the stable diffusion model 170 generates 16 attention tensors. The stable diffusion model 170 generates tensors of different dimensions. Specifically, of the 16 tensors generated by the diffusion model 170, 5 of them have dimension 64×64×64×64, 5 have 32×32×32×32, 5 have 16×16×16×16 and 1 has 8×8×8×8. The attention aggregator 152 aims to aggregate self-attention tensors of different resolutions into the highest resolution tensor. To achieve this, the segmentation engine 145 treats the 4 dimensions differently. As discussed previously, the 2D map Aₖ[I, J, :, .] corresponds to the correlation between all spatial locations to the location (I, J). Therefore, the last 2 dimensions in the self-attention maps are spatially consistent despite different resolutions. Therefore, the attention aggregator 152 up-samples, for example through bi-linear interpolation, the last 2 dimensions of all self-attention maps to 64×64 the highest resolution of them. Formally, for Aₖ∈ [symbol] ^{(h}^{ₖ}^{×w}^{ₖ}^{,h}^{ₖ}^{×w}^{ₖ}⁾:

$${k}_{} = Bilinear - upsample ( {k}_{} ) ∈ {{h}_{k} \times {w}_{k} \times 64 \times 64}^{} . \qquad ( 2 )$$

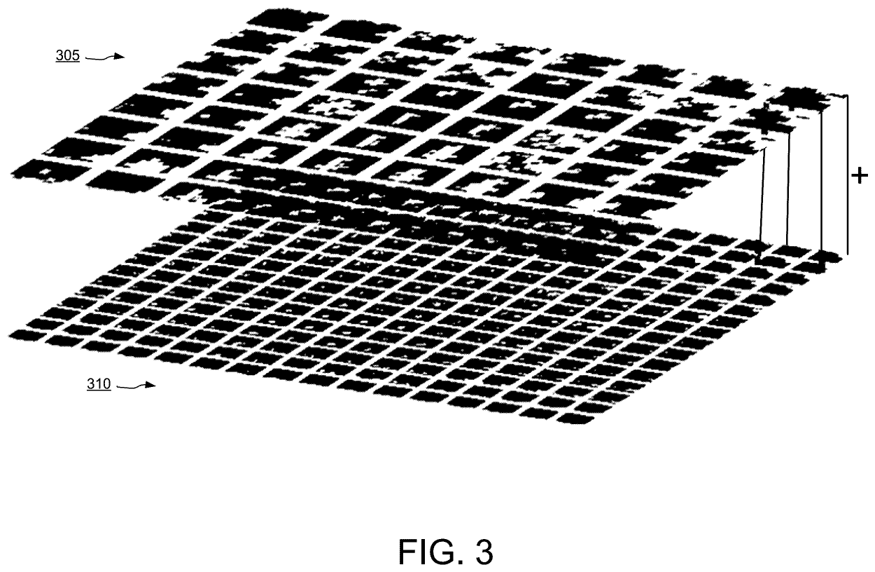

On the other hand, the first 2 dimensions indicate the locations to which self-attention maps are centered around. Therefore, the attention aggregator 152 needs to aggregate self-attention maps accordingly. Put another way, a self-attention map from a lower resolution is first up-sampled and then added to several corresponding high-resolution maps. For example, as shown in FIG. 3, the self-attention map 305 in the (0, 7) location in Aₖ∈ [symbol] ⁸ is first up-sampled and then repeatedly aggregated pixel-wise with the 4 self-attention maps (0, 14), (0, 15), (1, 15), (1, 14) in A_{z}∈ [symbol] ¹⁶^{⁴} (self-attention map 310 of FIG. 3). Put another way, a portion (in the (0, 7) location) of self-attention map 305 corresponds to a portion (in the (0, 14), (0, 15), (1, 15), (1, 14) location) of the self-attention map 310, and the portion of self-attention map 305 is up-sampled before being added to the portion of self-attention map 310. Formally, the final aggregated attention tensor A_{f}∈ [symbol] ⁶⁴^{⁴} is,

$${𝒜}_{f} [ I , J , : , : ] = {\sum }_{k ∈ \{ 1 , … , 16 \}} {𝒜}_{k} [ I , {δ}_{k} , J / {δ}_{k} , : , : ] * {R}_{k} , where {δ}_{k} = 64 / {w}_{k} , {\sum }_{k} {R}_{k} = 1. \qquad ( 3 )$$

where / denotes floor division and Rₖ represents a weight assigned to the k^{th} tensor, which has resolution wₖ. Put another way, the output of the attention aggregator 152 is a plurality of 2D aggregated attention maps stored in a 2D data structure, denoted as A_{f}. An aggregated attention map may also be referred to as a correspondence map. Thus, the aggregated attention tensor may be referred to as correspondence mappings (a plurality of correspondence mappings).

To ensure that the aggregated attention map is a valid distribution, i.e., ΣA_{f}[I, J, :, :]=1, the attention aggregator 152 may normalize A_{f}[I, J, :, :] after aggregation. In some implementations, the attention aggregator 152 may use an aggregation importance ratio Rₖ to assign weights during aggregation. In such implementations, the attention aggregator 152 may assign every self-attention map of different resolution a weight proportional to its resolution Rₖ∝wₖ. The weights R are hyper-parameters controlling a tradeoff between detail and large objects. Giving more weight to high-resolution self-attention maps leads to more detailed but potentially more fractured segmentation, whereas highlighting low-resolution self-attention maps gives more coherent segmentation for large objects. Some implementations may tune them for specific datasets. Some implementations may not tune the weights for specific data sets.

The segmentation engine 145 also includes the attention merger 154. The iterative attention merger 154 uses an iterative merging process based on anchor points in a sampling grid to generate, for each portion of the image, a set of possible object assignments. The sampling grid represents evenly-spaced anchor points, each anchor point being associated with a respective aggregated attention map in the aggregated attention tensor. Put another way, each anchor point is associated with a portion of the image corresponding to an aggregated attention map, referred to as an anchor portion. Initially, each anchor point represents a different proposed object in the image. In subsequent merging iterations, the iterative attention merger 154 reduces the set of proposed objects by merging similar aggregated attention maps, e.g., merging aggregated attention maps with a KL distance below a threshold. Unlike conventional clustering-based unsupervised segmentation methods, the segmentation engine 145 does not require specifying the number of clusters, represented as layers in the segmentation mask, beforehand. Also unlike conventional clustering-based unsupervised segmentation methods, the segmentation engine 145 is deterministic. Put another way, given an image, e.g., input image 105 and without any prior knowledge, the attention aggregator 152, attention merger 154, and non-maximum suppressor 158 of the segmentation engine 145 can produce a quality segmentation, e.g., segmentation mask 110, without resorting to any additional resources.

More specifically, the attention merger 154 aims to merge the 4096 maps (the first two dimensions of the aggregated attention tensor are 64×64, which represents 4096 aggregated attention maps) in the tensor A_{f} to a stack of, e.g., at least two, valid object-focused attention maps where each object-focused attention map likely contains the activation of a single object or stuff category.

The naive solution is to run a K-means algorithm on A_{f} to find clusters of objects following existing works in unsupervised segmentation. However, the K-means algorithm requires the specification of the number of clusters. This is not an intuitive hyper-parameter to tune because the goal of the attention merger 154 is to segment any images in the wild. Moreover, the K-means algorithm is stochastic depending on the initialization. Each run can have drastically different results for the same image. Instead, the attention merger 154 uses an input from a grid generator 156 that generates a sampling grid from which the attention merger 154 can iteratively merge aggregated attention maps to create object-focused maps. Specifically, as shown in FIG. 1B, grid generator 156 generates a set of M×M (1≤M≤64) evenly spaced anchor points, where [symbol] ={(iₘ,jₘ)|m=1, . . . , M²}. The sampling grid generator 156 then samples the corresponding aggregated attention maps from the tensor A_{f}. Formally, this operation yields a set of M² 2D attention maps as anchors (the set of anchors being represented by Lₐ):

$${ℒ}_{a} = \{ {𝒜}_{f} [ {i}_{m} , {j}_{m} , : , : ] ∈ {ℝ}^{64 \times 64} \vert ( {i}_{m} , {j}_{m} ) ∈ ℳ \} . \qquad ( 4 )$$

Because the goal of the attention merger 154 is to merge aggregated attention maps to find the maps most likely containing an object, the attention merger 154 may rely on intra-attention similarity and inter-attention similarity. Specifically, when iteratively merging “similar” maps, Intra-Attention Similarity reinforces the activation of an object and Inter-Attention Similarity grows the activation to include as many pixels of the same object within the merged map. To measure similarity, the attention merger 154 may use KL divergence to calculate the “distance” between two aggregated attention maps, because each aggregated attention map A_{f}[i, j, :, :](abbreviated A_{f}[i,j]) is a valid probability distribution. KL divergence is a measure of how one probability distribution P is different from a second, reference probability. Formally,

$$2 * D ( {𝒜}_{f} [ i , j ] , {𝒜}_{f} [ z , y ] ) = ( KL ( {𝒜}_{f} [ i , j ] ‖ {𝒜}_{f} [ z , y ] ) + KL ( {𝒜}_{f} [ z , y ] ‖ {𝒜}_{f} [ i , j ] ) ) . \qquad ( 5 )$$

Implementations may use both forward and reverse KL to address the asymmetry in KL divergence. Intuitively, a small [symbol] ( ) (small KL divergence) indicates high similarity between two attention maps and that the union of them is likely to better represent the object they both belong to. Then the attention merger 154 may start the N iterations of the merging process. In the first iteration, the attention merger 154 may compute the pairwise distance between each element in the anchor set and all 4096 aggregated attention maps using [symbol] ( ). The attention merger 154 may introduce a threshold parameter r and for each element in the list of anchor points, average all attention maps with a distance smaller than the threshold, effectively taking the union of attention maps likely belonging to the same object that the anchor point belongs to. All merged attention maps are stored in a new proposal set Lₚ.

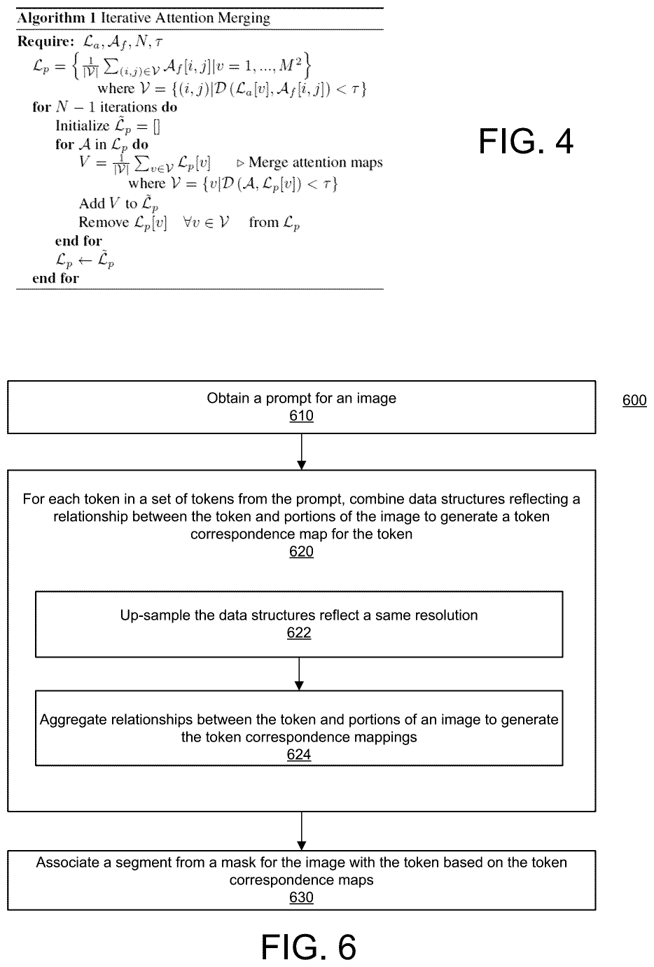

Note that the first iteration does reduce the number of object proposals compared to the number of anchors. From the second iteration onward, the attention merger 154 starts merging maps and reducing the number of proposals simultaneously by computing the distance between an element from the proposal set Lₚ and all elements from the same set, and merging elements with distance smaller than τ without replacement. An example iterative attention merging process performed by the attention merger 154 is provided in FIG. 4. Most of the process can be efficiently implemented to take advantage of the parallelism on GPUs.

The segmentation engine 145 also includes the non-maximum suppressor 158. The non-maximum suppressor 158 is configured to generate a segmentation mask 110 from the output of the attention merger 154. The attention merger 154 yields a set Lₚ∈ [symbol] ^{(N}^{ₚ}^{×64×64)} of Nₚ object proposals in the form of attention maps (probability maps). Each element in the set potentially contains the activation of an object. To convert the set into a valid segmentation mask, the non-maximum suppressor 158 uses non-maximum suppression (NMS) to determine an object assignment for each portion (spatial location) of the input image. This can be done because each element is a probability distribution map. The non-maximum suppressor 158 can take the index of the largest probability at each spatial location across all maps and assign the membership of that location to the index of the corresponding map. Note that, before the non-maximum suppression, implementations may first up-sample all elements in Lₚ to the original resolution. Formally, the final segmentation mask S∈ [symbol] ^{(512×512)} is

$$\begin{matrix}{\overline{ℒ}}_{p} = Bilinear - upsample ( {ℒ}_{p} ) ∈ {ℝ}^{{N}_{p} \times 512 \times 512} \\ \begin{matrix}𝒮 [ i , j ] = arg max {\overline{ℒ}}_{p} [ : , i , j ] & ∀ i , j ∈ \{ 0 , … , 511 \} .\end{matrix}\end{matrix} \qquad ( 6 )$$

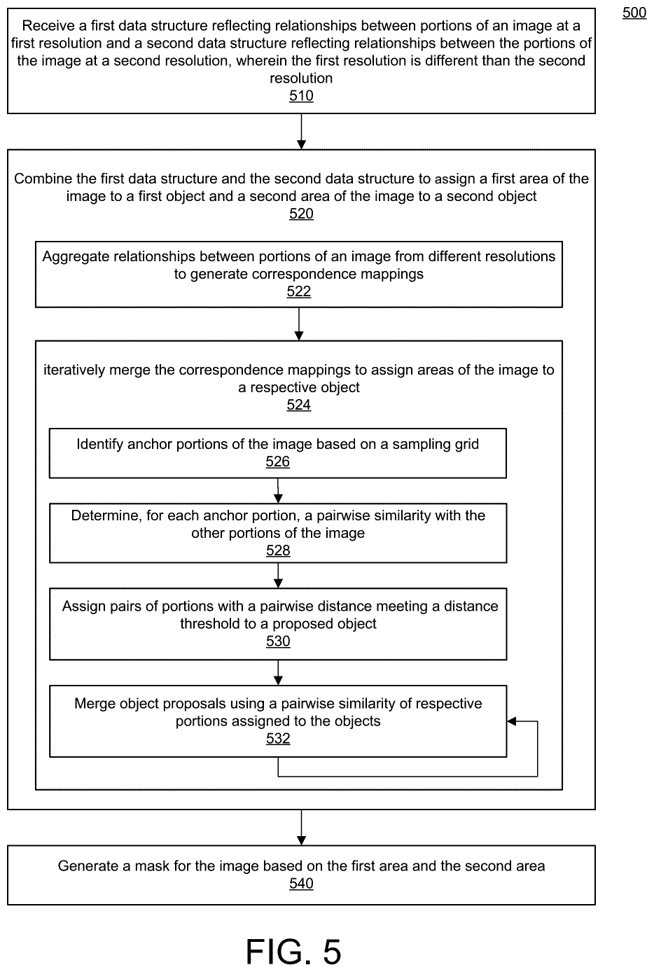

FIG. 5 illustrates an example method 500 for generating a segmentation map, according to disclosed implementations. The method 500 operates on the self-attention tensors of a single denoising pass of an input image by a generative image model (such as a stable diffusion model) as input and provides a segmentation mask for the input image as output. The self-attention tensors are data (data structures) that reflect relationships between portions of the input image. The method 500 can be performed by a computing device, such as computing device 130 of FIG. 1A. The method 500 can be performed by a segmentation engine 145.

The method 500 includes step 510, where the system receives a first data reflecting relationships between portions of an image at a first resolution and a second data structure reflecting relationships between the portions of the image at a second resolution, wherein the first resolution is different than the second resolution. The first data and the second data are arrays of self-attention maps. A self-attention map reflects relationships between the portion of the image it represents and other portions of the image. The relation may be a probability reflecting likelihood of the two portions belonging to the same object in the image. Each attention map is for a particular spatial location, or portion, of the image. Put another way, the input image may be divided into equal portions having particular dimensions (width and height). Different data structures (e.g., tensors) can be for different resolutions. A data structure with a higher resolution has more self-attention maps, but the self-attention maps represent smaller portions of the image. Thus, the resolution of the first data refers to the size of the portion of the image covered by the self-attention map. As an example, the first data may be a 4-dimensional data with a resolution of 8×8×8×8, 16×16×16×16, . . . 64×64×64×64, etc. Each higher resolution is a multiple of a lower resolution.

At step 520 the method includes combining the first data and the second data to assign a first area of the image to a first object and a second area of the image to a second object. Step 520 can include aggregating relationships between portions of an image from different resolutions to generate correspondence mappings (step 522) and iteratively merging the correspondence mappings to assign areas (portions) of the image to a respective object (step 524). In some implementations, step 522 can include up-sampling lower resolution data to higher resolution data and adding the self-attention maps representing the same location (same area, same portion) of the image. In some implementations, with a plurality of data, up-sampling may be done until all data are at a same resolution, e.g., a highest resolution. In implementations where the data are all at a same resolution, no up-sampling needs to be done. In some implementations, relationships (e.g., self-attention maps) can be aggregated by addition.

Step 524 may include identifying anchor portions of the image based on a sampling grid (step 526). The sampling grid may include a predetermined number of evenly spaced anchor points. The anchor points each correspond to a respective portion of the image, which is referred to as an anchor portion. Each anchor portion of the image has a respective correspondence map (aggregated attention map). At step 528, the system may determine, for each anchor portion, a pairwise similarity with other portions of the image. The pairwise similarity may be based on a KL distance. Put another way, each pairwise distance represents similarity between an anchor portion and another portion of the image, referred to as a portion pair. At step 530, the pairwise distances are compared to a predetermined distance threshold T. Portion pairs with a respective pairwise distance that meets the distance threshold are assigned to a proposed object. Where a smaller pairwise distance reflects higher similarity, a pairwise distance less than or equal to the distance threshold meets the distance threshold. Where a larger pairwise distance reflects higher similarity, a pairwise distance greater than or equal to the distance threshold meets the distance threshold. Each anchor portion is thus paired with all other portions likely belonging to the same object that the anchor portion belongs to. These pairings represent a set or group of proposed objects.

At step 532, the system may merge object proposals. Merging may occur based on pairwise similarity of respective portions assigned to the object. Consider we have a list (series) Lₚ of object proposals consisting of M elements, i.e., Lₚ={p₁, p₂, p₃, p₄, p₅, p₆, . . . , p_{M}}, where pi is a set of object proposals for an anchor point (from step 530). Put another way, the list Lₚ can be referred to as a series of proposed object groups. As part of step 532 the system may take element p₁ and find its distance, e.g., KL divergence, with every other element in Lₚ, i.e., with every other proposed object group. For all comparisons that yield a distance smaller than τ, the object proposal is merged together. As an example, suppose for p₁, distance with p₂ and p₅ is smaller than τ, then the resultant object proposal list will be Lₚ₁={p_{125_merged}, p₃, p₄, p₆, . . . , p_{M}}, where p_{125_merged} refers to the merger of {p₁, p₂, p₅}. Because step 532 is without replacement, the system may omit the elements which were found similar to p₁, i.e., they are no longer separately part of the grouped object proposals but are represented by p_{125_merged}. Then, the system would continue finding the distance of the next element, in this case p₃, with all elements remaining in the list, and so on. Thus, for example, p₃ may be merged with p₄, p₆, and p₁₅. The next element may then be p₇, for which the distance is computed with all elements remaining in the list, etc. This may be done for a predetermined number of iterations. At the end of the predetermined iterations, step 532 results in a set of object proposals in the form of attention maps (probability maps).

In some implementations, non-maximum suppression may be used to identify respective objects to which portions of the image are assigned. The respective objects may be referred to as final objects and represent objects with a highest (top-scoring) probability (as determined by the probability maps) for areas of the image. Put another way, the probability maps correspond with areas of the image and the probability maps are associated with respective objects (e.g., final objects). Accordingly, as a result of step 520, a first area is assigned to a first object and a second area of the image is assigned to a second object, etc. At step 540 the system may generate a segmentation mask for the image based on the first area and the second area. The segmentation mask or a portion of the segmentation mask (e.g., a layer) can then be used to identify a portion of the image for further processing. Further processing can include entity recognition, semantic labeling, making a portion of the image actionable, analyzing a portion of the image, removing a portion of the image, replacing a portion of the image, or any other computer vision task. In some implementations, analyzing the portion of the image may be done by a machine-learned model.

### Semantics for the Diffusion Segmentation Model

Some implementations may add semantics to segmentation masks. The segmentation masks generated by disclosed implementations do not identify what object may be represented by a layer, e.g., segment, of the segmentation mask. Put another way, the segmentation mask lacks any label. Some implementations may be configured to add labels to the segments of the segmentation mask using a prompt provided with the image to the generative image model. With the prompt, implementations may use cross-attention to ground each layer in the segmentation mask to a specific token or tokens in the prompt.

FIG. 1B illustrates additional components of the segmentation engine 145 that may be used to provide label assignments to the layers of the segmentation mask. In implementations that add label assignments, the segmentation engine 145 may additionally include a description generator 160, cross-attention extractor 162, and label generator 164. In some implementations, the prompt may be a prompt used to generate the image. In some implementations, the prompt may be a description of the input image 105. In such implementations, the description generator 160 may include or may have access to a captioning model 161. The captioning model 161 may be trained to generate a caption for a given image using known or later developed techniques.

Whether the prompt is one provided to the description generator 160 or obtained by the description generator 160, e.g., from the captioning model 161, the prompt includes one or more words. The words can also be referred to as tokens. In some implementations, the prompt may include additional tokens that are not words, such as a token representing a beginning of a sentence, a token representing an end of a sentence, or a token representing punctuation. The description generator 160 may provide the prompt as input to the diffusion model 170 with the input image 105. In some implementations, the description generator 160 may tokenize the prompt before providing the prompt to the diffusion model 170. The tokenization process may add beginning of sentence tokens and/or end of sentence tokens. The end of sentence may be added to a fixed length. For example, some diffusion models 170 may expect a prompt of a predetermined length. In some implementations, the description generator 160 may pad the prompt with end of sentence tokens. When a prompt is provided with the input image, meaningful grounded cross-attention maps can be extracted.

The description generator 160 may extract all nouns from the prompt, generating a set of tokens from the prompt. The nouns can include noun phrases. Put another way, the description generator 160 may filter out tokens in the prompt that are not a noun or part of a noun phrase from the set of tokens. The tokens that are filtered out may include, but are not limited to, prepositions, words with predetermined endings such as ‘ly’, ‘ed’ and ‘ing’, tokens that represent a beginning of a sentence, punctuation, special characters, etc. In addition to extracting nouns (including noun phrases), the description generator 160 may track the position of the extracted nouns in the prompt. The position may be a number indicating where, in the order of tokens from the prompt, the token appears. A noun repeated in the prompt may be associated with two or more positions. Thus, the description generator 160 may generate token lists 163. The token lists 163 pair extracted tokens, i.e., from the set of tokens,

with their respective position/positions in the prompt. The token lists 163 can also be referred to as a set of indices for the extracted nouns.

The cross-attention extractor 162 may be configured to receive the token lists 163 and the cross-attention layer 176 of the transformer layers of the diffusion model 170. As discussed above, cross-attention is used to learn attention between the image and tokens from the prompt. Each cross-attention layer 176 produces a cross-attention map for each token. The cross-attention map for a token may be referred to as representing relationships between the token and portions of the image. As with the self-attention layers, the cross-attention layers are also of different resolutions. In some implementations, the cross-attention information may be from a single denoising pass through the diffusion model 170. This may work better for prompts (text) describing a real image. In some implementations, the cross-attention information may be from a single forward pass through the diffusion model 170. This may work better for images generated from a prompt.

The cross-attention extractor 162 may use the set of indices (e.g., token lists 163) to identify the cross-attention maps for extraction. Put another way, the token lists 163 extracts the cross-attention maps that correspond to tokens represented in the token lists 163. The cross-attention extractor 162 thus uses a portion of the relationships (cross-attention maps) between tokens in the prompt and portions of the image.

Similar to the self-attention formulation in equation (1) above, in some implementations there are a total 16 cross-attention layers in the diffusion model 170, resulting in 16 cross-attention tensors A_{c}. The cross-attention tensors can be represented as:

$${𝒜}_{𝒞} ∈ \{ {𝒜}_{c} ∈ {ℝ}^{{h}_{c} \times {w}_{c} \times Q} \vert c = 1 , … , 16 \} . \qquad ( 7 )$$

where Q represents the number of tokenized words in the prompt. In some stable diffusion models, Q=77. However, unlike the self-attention tensors, the cross-attention tensor is a 3-dimensional tensor, where each A_{c}[:, : , q]∈ [symbol] ^{(h}^{_{c}}^{×w}^{_{c}}⁾, ∀_{q}∈{1, . . . , Q} is the un-normalized cross-attention map with respect to token q. FIG. 2B illustrates a visualization of example cross-attention maps, according to disclosed implementations. The cross-attention extractor 162 extracts cross-attention maps corresponding only to nouns in the token lists 163. Where the cross-attention extractor 162 pads the prompt with a beginning of sentence token, the index of a token in the token lists 163 may be off by one. In such an implementation, one may be added to the index to determine which cross-attention tensors to extract. The cross-attention extractor 162 may output a cross-attention tensor A_{N} corresponding only to the noun tokens. This may be represented as

$${𝒜}_{𝒩} ∈ \{ {𝒜}_{n} ∈ {ℝ}^{{h}_{n} \times {w}_{n} \times L} \vert n = 1 , … , 16 \} . \qquad ( 8 )$$

where L corresponds to the number of indices in the token lists 163 (e.g., where a noun appears twice in a prompt, it will correspond with two indices in the token lists 163).

The label generator 164 may be configured to aggregate the cross-attention tensors that correspond to the tokens in the token lists 163 (e.g., as extracted by the 162), and provide label assignments to portions of the image. As with the self-attention tensors, the cross-attention maps in the cross-attention tensors may also be of different resolutions, so the token lists 163 may up-sample the first two dimensions of each cross-attention map to a common resolution. In some implementations, the common resolution may be 512×512. Up-sampling the cross-attention maps may be represented as

$${𝒜}_{n} = Bilinear - upsample ( {𝒜}_{n} ) ∈ {ℝ}^{512 \times 512 \times L} . \qquad ( 9 )$$

The label generator 164 may sum and normalize all cross-attention maps to obtain an aggregated cross-attention tensor A_{nf}∈ [symbol] ^{(512×512×L)}. The aggregated cross-attention maps may also be referred to as token correspondence maps. Specifically, the aggregated cross-attention map, i.e., token correspondence map, corresponding to token l can be expressed as:

$${𝒜}_{nf}^{l} = \frac{{\sum }_{n = 1}^{10} {\tilde{𝒜}}_{n} [ : , : , l ] ]}{{\sum }_{w = 1}^{512} {\sum }_{h = 1}^{512} {\sum }_{n = 1}^{16} {\tilde{𝒜}}_{n} [ w , h , l ]} . \qquad ( 10 )$$

To make label assignments to a segment of a segment mask, and by extension to an area of the image, the label generator 164 may combine the token correspondence maps for all tokens in the token lists 163 (e.g., A_{nf}) with the segmentation mask, which includes N layers (N different objects/segments). Specifically, for each layer, the label generator 164 may calculate a prediction vector lₙ_{ₚ}∈ [symbol] ^{L}. Each element in the prediction vector can be calculated as

$${l}_{{n}_{p}}^{i} = {ℒ}_{p} [ {n}_{p} , : , : ] {𝒜}_{n , f} [ : , : , i ] . \qquad ( 11 )$$

where [symbol] denotes the element-wise product, i represents the element, and n represents a segment (layer) in the segmentation mask. The label generator 164 assigns a label to a segment by taking the maximum element in the prediction vector lₙ_{ₚ}. The label generator 164 may merge all layers with the same label into a single layer, as illustrated by label assignments 115a, 115b, and 115c in FIG. 1B.

FIG. 6 illustrates an example method 600 for generating a label assignment for a segment of a segmentation mask, according to disclosed implementations. The method 600 operates on the cross-attention tensors of a single pass of an input image and a prompt by a generative image model (such as a stable diffusion model) and provides label assignments to a segmentation mask generated for the image. The single pass can be a single denoising pass. The single pass can be a forward pass. The cross-attention tensors are data (data structures) that reflect relationships between tokens in the prompt and portions of the input image. The method 600 can be performed by a computing device, such as computing device 130 of FIG. 1A. The method 600 can be performed by a segmentation engine 145.

The method 600 includes step 610, where a prompt for the image is obtained. The prompt may be a prompt used to generate the image. The prompt may be a caption generated for the image. Step 620 includes combining data reflecting a relationship between a token and portions of the image. The token is a token in a set of tokens from the prompt. The set of tokens may include nouns identified in the prompt. The combining is done for each token in the set of tokens. Combining the data generates a token correspondence map for the token. The data reflecting the relationship between the token and the portions may be a cross-attention map generated by a model, such as a stable diffusion model. In some implementations, the combining can include up-sampling the data to reflect a same resolution (step 622). In some implementations, the system may aggregate the relationships between tokens and portions of an image (step 624). Aggregating the relationships may include aggregating the cross-attention maps for the token, as described herein.

At step 630 the method includes associating a segment from a segment mask for the image with a token based on the token correspondence maps. The segment mask is a segment mask generated using disclosed techniques. Step 630 may include merging or combining the segments with a same associated label. For example, if two different segments of the segment mask are assigned to the same label, implementations may merge the two segments into the same segment. Step 630 may include merging or combining the segments labeled with the tokens in a noun phrase.

An evaluation of a non-limiting example implementation follows, illustrating the technical benefits of the disclosed methods and systems. In the following examples, the model represented by disclosed implementations is referred to as DiffSeg for ease of explanation. The example evaluation uses two popular segmentation benchmarks, COCO-Stuff-27 and Cityscapes. COCO-stuff-27 is a curated version of the original COCO-stuff dataset. Specifically, COCO-stuff-27 merges the 80 things and 91 stuff categories in COCO-stuff into 27 mid-level categories. The evaluation is on the validation split curated by prior works. Cityscapes is a self-driving dataset with 27 categories. The evaluation is on the official validation split. For both datasets, the example implementation resizes input images along the minor axis to 512 and center-crop to 512×512 pixels. Other existing solutions use 320×320 resolution while the diffusion model uses 512×512 input resolution. Being able to accommodate higher resolution input is a strength of diffusion models.

Pixel accuracy (ACC) and mean intersection over union (mIoU) are used to measure segmentation performance of the example implementation. Because disclosed implementations do not provide a semantic label, the Hungarian matching algorithm is used to assign each predicted mask to a ground truth mask. When there are more predicted masks than ground truth masks, the unmatched predicted masks are taken into account as false negatives. In the following evaluations, an example implementation labeled DiffSeg-V1 uses a first version of a pre-trained stable diffusion model and another example implementation labeled DiffSeg-V2 uses a second version of the pre-trained stable diffusion model.

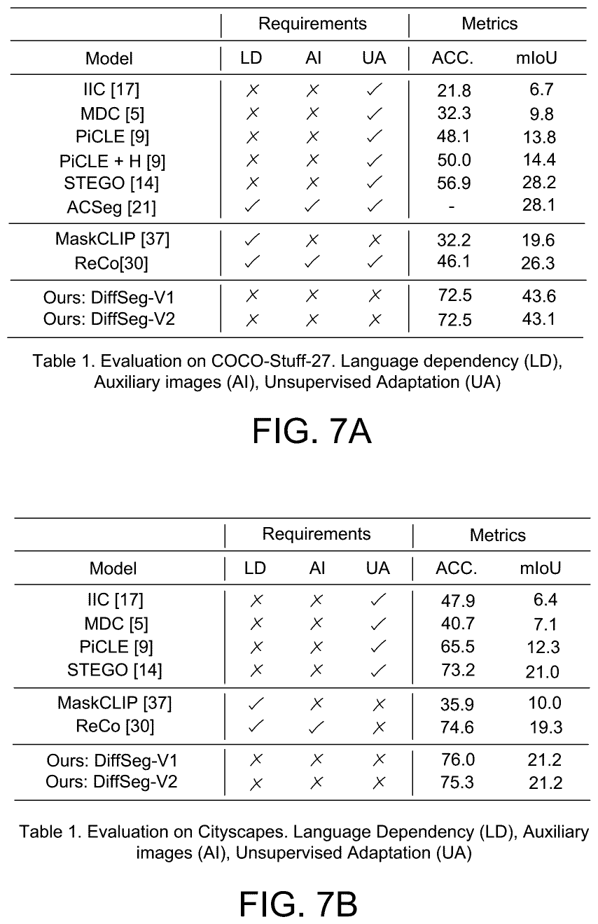

FIG. 7A illustrates evaluation of disclosed implementations (DiffSeg-V1 and DiffSeg-V2) against existing systems on COCO-Stuff-27. FIG. 7B illustrates disclosed implementations (DiffSeg-V1 and DiffSeg-V2) against existing systems on Cityscapes. In addition to the ACC and mIoU metrics, FIG. 7A and FIG. 7B also highlight the requirements participating works need to run inference. A check means the requirement is needed, an x means not required. Specifically, the requirements emphasized include unsupervised adaptation (UA), language dependency (LD), and auxiliary image (AI). UA means that the specific method requires unsupervised training on the target dataset. Methods without the UA requirement (labeled with an x in FIGS. 7A and 7B) are considered zero-shot. LD means that the method requires text input such as a descriptive sentence for the image, to facilitate segmentation. Similarly, AI means that the method requires additional image inputs either in the form of a pool of reference images or synthetic images. FIG. 7A illustrates that disclosed implementations, DiffSeg-V1 and DiffSeg-V2, significantly outperform existing zero-shot method ReCo by an absolute 26% in accuracy and 17% in mIoU ReCo. On the more specialized self-driving segmentation task (Cityscapes), FIG. 7B illustrates that disclosed implementations also outperform existing zero-shot methods in both accuracy and mIoU. DiffSeg-V1 and DiffSeg-V2 performed similarly. This may be because the main improvement from stable diffusion v1 to v2 is in a new text encoder, which is not part of disclosed implementations, and both models are trained on the same datasets. Compared to existing solutions, disclosed implementations achieve this level of performance in a pure zero-shot manner without any language dependency or auxiliary images. Therefore, disclosed implementations are more suitable for segmenting images in the wild, similar to SAM. The hyperparameters used are included in Table 3 and their sensitivity is discussed next.

TABLE 3

| Name | COCO | Cityscapes |
|---|---|---|
| Aggregation weights (R) | Propto. | Propto. |
| Time step (t) | 300 | 300 |
| Num. of anchors (M²) | 256 | 256 |
| Num. of merging iterations (N) | 3 | 3 |
| KL threshold (τ) | 1.1 | 0.9 |

There are several hyper-parameters listed in Table 3 used in disclosed implementations. Hyper-parameters are predetermined configuration variables. Most of the hyper-parameters used by disclosed implementations have a reasonable range that works well for general settings. Therefore, implementations need not tune the parameters specifically for each dataset and model. The listed numbers in Table 3 are the exact parameters used for FIGS. 7A and 7B. A discussion of the parameters follows.

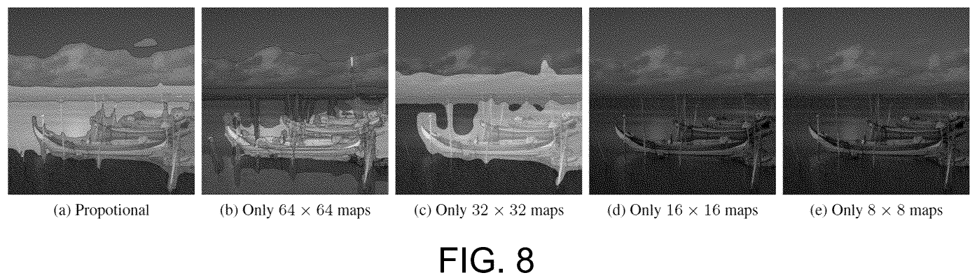

Aggregation weights (R). The first step of disclosed implementations is attention aggregation, where self-attention maps of 4 resolutions are aggregated together. Implementations may adopt a proportional aggregation scheme. Specifically, the aggregation weight for a map of a certain resolution is proportional to its resolution, i.e., high resolution maps are assigned higher importance. This is motivated by the observation that high resolution maps have a smaller receptive field with respect to the original image thus giving more details. To illustrate this, FIG. 8 illustrates the effects of using self-attention maps of different resolutions for segmentation while keeping other parameters constant (t=100, M²=256, K=3, τ=1.0). Put another way, FIG. 8 illustrates the effects of different aggregation weights (R) on an original image. FIG. 8 illustrates that high-resolution maps, e.g., 64×64 in image B of FIG. 7 yield the most detailed, however fractured segmentation. Lower-resolution maps, e.g., 32×32 in image C of FIG. 7, give more coherent segmentation but often over-segment details, especially along the edges. Finally, too low resolutions fail to generate any segmentation in image D of FIG. 8 because the entire image is merged into one object given the current hyperparameter settings. Image A of FIG. 8 demonstrates a proportional aggregation strategy (higher resolution maps are assigned higher weights) that balances consistency and detailedness.

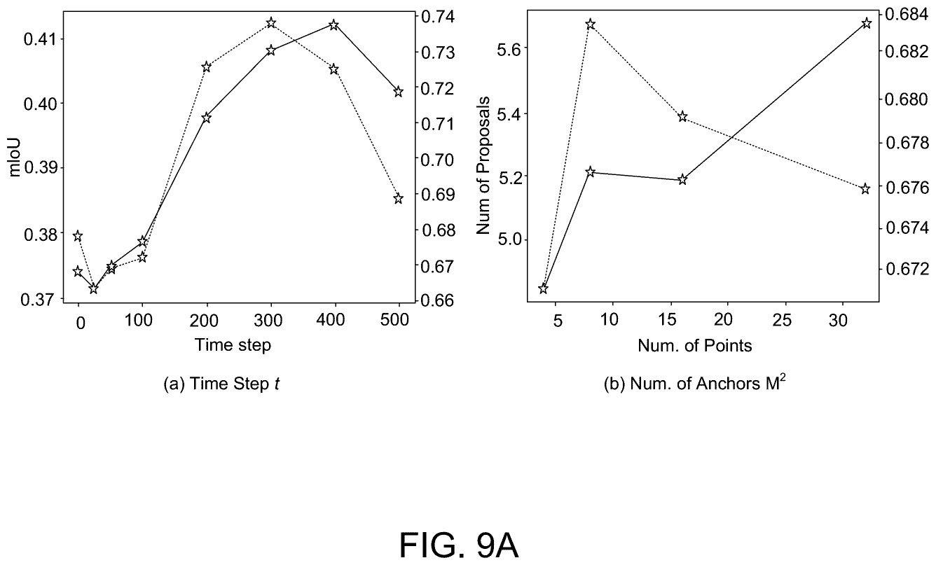

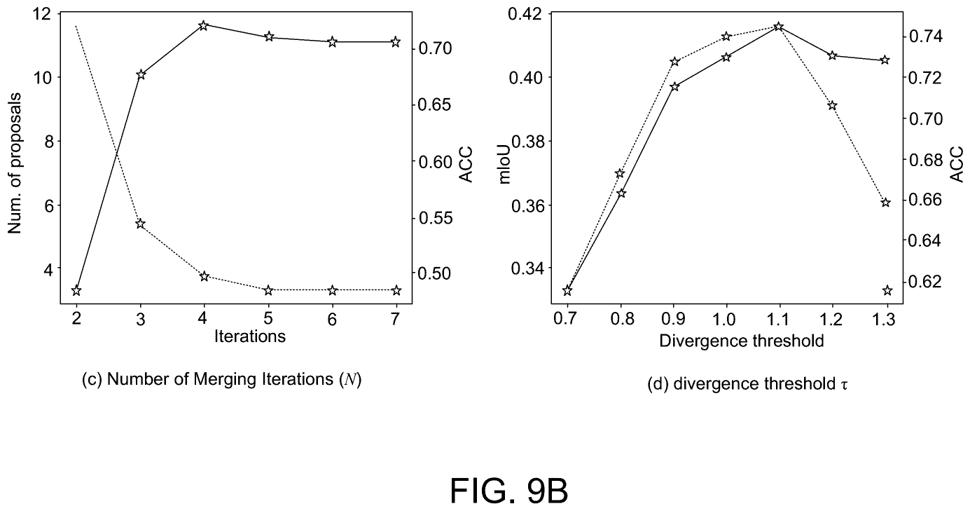

Time step (t). The stable diffusion model requires a time step t to indicate the current stage of the diffusion process. Because implementations only run a single pass through the diffusion process, the time step becomes a hyper-parameter. Graph (a) of FIG. 9 demonstrates the effects of setting this parameter to different numbers t∈{1, 100, 200, 300, 400, 500} while keeping the other hyper-parameters constant (R=proportional, M²=256, N=3, τ=1.0). Graph (a) of FIG. 9 illustrates a general upward trend for accuracy (in blue) and mIoU (in red) when increasing the time step, which peaked around t=300. t=300 can be used for some implementations.

Number of anchors (M²). Implementations generate a sampling grid of M² anchors to start off the attention-merging process. Graph (b) of FIG. 9, shows the number of proposals and accuracy with different numbers of anchor points M∈{4, 8, 16, 32} while keeping the other hyper-parameters constant (R=proportional, t=100, N=3, τ=1.0). Graph (b) of FIG. 9 illustrates that the number of anchor points does not have a significant effect on the performance of COCO-Stuff-27. A default of M=16 can be selected as minimizing number of proposals and accuracy.

Number of merging iterations (N). The iterative attention merging process of disclosed implementations occurs (runs) for a predetermined number of (e.g., N) iterations. Intuitively, the more iterations, the more proposals will be merged. Graph (c) of FIG. 9, shows the effects of increasing the number of iterations N∈{, 2, 3, 4, 5, 6, 7} in terms of the number of final objects and accuracy while keeping the other hyper-parameters constant (R=proportional, M²=256, t=100, τ=1.0). Graph (c) of FIG. 9 illustrates that at the third iteration, the number of proposals drops to a reasonable amount and the accuracy remains similar afterward. Therefore, implementations may use N=3 for a better system latency and performance tradeoff.

Divergence threshold (τ). The iterative attention merging process also requires specifying the KL threshold τ, also called a divergence threshold. It is arguably the most sensitive hyper-parameter and may be tuned separately for each dataset. Too small a threshold leads to too many proposals and too large leads to too few proposals. Graph (d) of FIG. 9 illustrates the effect of τ∈{0.7, 0.8, 0.9, 1.0, 1.1, 1.2, 1.3} while using the validated values for the other hyper-parameters (R=proportional, M²=256, I=100, N=3). A range τ∈[0.9, 1.1] yields reasonable performance. In the examples of FIG. 9, τ=1.1 for COCO-Stuff-27 and τ=0.9 for Cityscapes.

A Note on the Parameters. The same set of (R, t, M, N) works generally well for different settings. The KL threshold parameter τ is more sensitive. A reasonable range for the divergence threshold parameter τ is between 0.9 and 1.1. A default τ=1.0 is suggested for the segmentation of images in the wild. For the best benchmark results, different implementations may use a different selection of the hyperparameter.

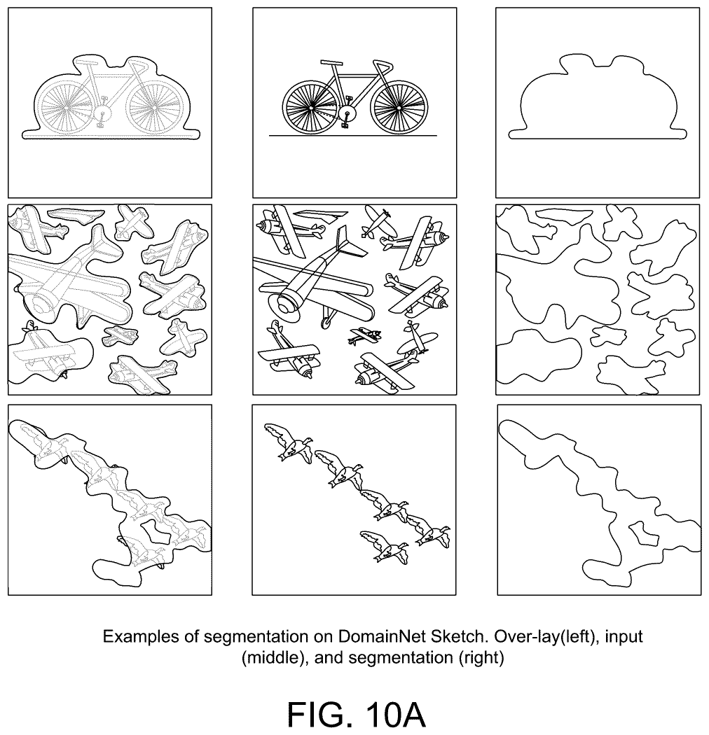

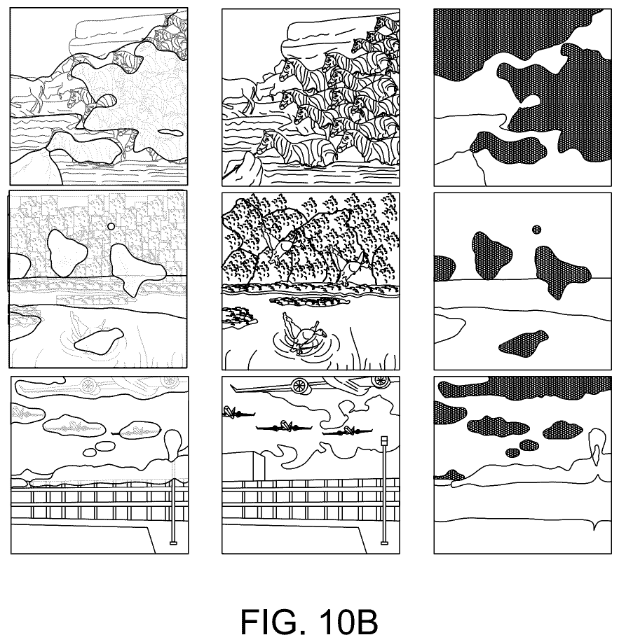

To demonstrate the generalization capability of disclosed implementations, FIGS. 10A and 10B provide examples of segmentation on images of different styles. Specifically, FIGS. 10A and 10B show segmentation on several sketches and paintings. The images are taken from the DomainNet dataset. FIGS. 10A and 10B demonstrate that implementations are able to include similar objects in the same segmentation layer, even when they are not touching in the image. Implementations can therefore be used to generate masks for synthetic images of diverse styles, generated by a stable diffusion model. Note that for segmenting generated images, implementations may only take the attention tensors from the last diffusion step. This enables implementations to be a viable choice for creating segmentation datasets. Semantic labels can be easily obtained in a second stage using a pre-trained vision-language model in a zero-shot manner.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are remote from each other and typically interact through a communication network. The relationship of client and server arises by virtue of computer programs running on the respective computers and having a client-server relationship with each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

In some aspects, the techniques described herein relate to a method including: obtaining a first attention layer of a first resolution and a second attention layer of a second resolution from a first pass through a stable diffusion model, the stable diffusion model taking an image as input and the first resolution being higher than the second resolution; aggregating the first attention layer and the second attention layer to generate an attention tensor with a plurality of attention maps; iteratively merging the plurality of attention maps to generate at least two object-focused maps; and generating a segmentation mask for the image based on the at least two object-focused maps.

In some aspects, the techniques described herein relate to a method, wherein iteratively merging occurs a predetermined number of iterations.

In some aspects, the techniques described herein relate to a method, wherein aggregating the first attention layer and the second attention layer includes: up-sampling a portion of the second attention layer that corresponds to a portion of the first attention layer; and adding the up-sampled portion of the second attention layer to the portion of the first attention layer.

In some aspects, the techniques described herein relate to a method, further including providing a segmentation layer of the segmentation mask to a classifier, the classifier providing a classification prediction for a portion of the image that corresponds to the segmentation layer.

In some aspects, the techniques described herein relate to a method, wherein iteratively merging the plurality of attention maps includes: generating a set of anchors; calculate respective pairwise distances between anchors in the set of anchors and the plurality of attention maps; and merging attention maps at an anchor where the respective pairwise distance for the anchor is smaller than a divergence threshold.

In some aspects, the techniques described herein relate to a method, wherein generating the segmentation mask includes: generating a set of object proposals as probability maps; identify, for a spatial location, an object proposal from the set of object proposals with a highest probability; and assign the spatial location to membership in the object proposal.

In some aspects, the techniques described herein relate to a method, further including up-sampling the set of object proposals.

In some aspects, the techniques described herein relate to a method including: aggregating cross-attention maps from different resolutions of a stable diffusion model operating on an image, the stable diffusion model taking a prompt as input, the prompt having tokens describing the image; obtaining a predicted segmentation mask for the image; and for each predicted segment in the segmentation mask: identifying a token from the prompt with a highest aggregated cross-attention, and labeling the segment with the token.

In some aspects, the techniques described herein relate to a method, further including: filtering the cross attention maps and tokens corresponding to preposition words, a beginning of sentence token and an end of sentence token.

In some aspects, the techniques described herein relate to a method, further including: merging segments associated with the same label.

In some aspects, the techniques described herein relate to a method including: receiving a first data reflecting relationships between portions of an image at a first resolution and a second data reflecting relationships between the portions of the image at a second resolution, wherein the first resolution is different than the second resolution; combining the first data and the second data to assign a first area of the image to a first object and a second area of the image to a second object; and generating a mask for the image based on the first area and the second area.

In some aspects, the techniques described herein relate to a method including: aggregating relationships between tokens and portions of an image from different resolutions, the relationships being received from a denoising pass through a generative image model operating on the image, the generative image model taking a prompt as input, the prompt having tokens describing the image, wherein the aggregating generates respective token correspondence maps for the tokens; obtaining a mask for the image, the mask including at least two segments; and for a segment in the mask: identifying a token from the prompt with a highest respective token correspondence map, and labeling the segment with the token.

In some aspects, the techniques described herein relate to a method including: aggregating relationships between portions of an image from different resolutions to generate correspondence mappings; iteratively merging the correspondence mappings to assign areas of the image to a respective object; and generating a mask for the image based on the areas and the respective objects.

In some aspects, the techniques described herein relate to a method including: receiving first data reflecting relationships between portions of an image at a first resolution and second data reflecting relationships between the portions of the image at a second resolution, wherein the first resolution is different than the second resolution; combining the first data and the second data to assign a first area of the image to a first object and a second area of the image to a second object; and generating a mask for the image based on the first area and the second area.

In some aspects, the techniques described herein relate to a method, wherein combining the first data and the second data includes: up-sampling a portion of the second data that corresponds to a portion of the first data to the first resolution; and combining at least some of the relationships in the portion of the second data with the relationships in the portion of the first data.

In some aspects, the techniques described herein relate to a method, wherein areas of the image represented in the first data are assigned to one of a first number of portions and areas of the image represented in the second data are assigned to one of a second number of portions, the first number being a multiple of the second number, and combining the first data and the second data includes: up-sampling the portions of the image reflected in the second data structure; and adding the relationships of the first data and the relationships of the second data.

In some aspects, the techniques described herein relate to a method, wherein the first data is from a first layer of a stable diffusion model and the second data is from a second layer of the stable diffusion model, the first layer and the second layer being received from a single denoising pass of the stable diffusion model on the image.

In some aspects, the techniques described herein relate to a method, wherein a plurality of layers are received from the stable diffusion model, the relationships between portions of the image are represented by respective self-attention maps, and combining the plurality of layers includes: generating a plurality of aggregated attention maps; and iteratively merging the plurality of aggregated attention maps to generate a set of objects, the set of objects including the first object and the second object.

In some aspects, the techniques described herein relate to a method, wherein iteratively merging the plurality of aggregated attention maps includes: generating a set of anchors; calculating respective pairwise distances between anchors in the set of anchors and the plurality of aggregated attention maps; and merging aggregated attention maps at an anchor where the respective pairwise distance for the anchor is smaller than a divergence threshold.

In some aspects, the techniques described herein relate to a method, wherein assigning the first area to the first object includes: generating a set of object proposals as probability maps; identifying, for the first area, an object proposal from the set of object proposals with a highest probability; and assigning the first area to membership in the object proposal.

In some aspects, the techniques described herein relate to a method, wherein the mask includes a first segment for the first object and a second segment for the second object and the method further includes processing a portion of the image that corresponds to the first segment.

In some aspects, the techniques described herein relate to a method, wherein the mask includes a first segment for the first object and a second segment for the second object and the method further includes providing the image and the first segment to a machine-learned model, the machine-learned model analyzing a portion of the image that corresponds to the first segment.

In some aspects, the techniques described herein relate to a method including: aggregating relationships between tokens and portions of an image from different resolutions, the relationships being received from a generative image model operating on the image and a prompt, the prompt having tokens describing the image, wherein the aggregating generates respective token correspondence maps for the tokens; obtaining a mask for the image, the mask including at least two segments; and for a segment in the mask: identifying a token from the prompt with a highest respective token correspondence map, and labeling the segment with the token.

In some aspects, the techniques described herein relate to a method, further including: filtering a token and the respective token correspondence map for the token corresponding to a preposition word, a beginning of sentence token, or an end of sentence token.

In some aspects, the techniques described herein relate to a method, further including: merging segments associated with a same label.

In some aspects, the techniques described herein relate to a method, further including: merging segments associated with tokens in a noun phrase.

In some aspects, the techniques described herein relate to a method including: aggregating relationships between portions of an image from different resolutions to generate correspondence maps; iteratively merging the correspondence maps to assign areas of the image to a respective object; and generating a mask for the image based on the areas and the respective objects.

In some aspects, the techniques described herein relate to a method, wherein iteratively merging the correspondence maps includes: identifying anchor portions of the image based on a sampling grid; and using the anchor portions to determine pairwise similarities between the anchor portions and other portions of the image, wherein merging is based on the pairwise similarities.

In some aspects, the techniques described herein relate to a method, wherein iteratively merging the correspondence maps includes: identifying anchor portions of the image based on a sampling grid; and using the anchor portions to determine pairwise similarities between the anchor portions and other portions of the image, wherein merging is based on the pairwise similarities.

In some aspects, the techniques described herein relate to a method, wherein aggregating the relationships includes assigning a respective weight to different resolutions, the weight being used in the aggregation of the relationships between the portions.

In some aspects, the techniques described herein relate to a system comprising at least one processor and memory storing instructions that, when executed by the at least one processor, cause the system to perform any of the methods or processes disclosed herein.

In some aspects, the techniques described herein relate to a non-transitory computer-readable medium comprising instructions that, when executed by at least one processor, cause a computing device to perform any of the methods or processes disclosed herein.

What is claimed is:

1. A method comprising:
receiving first data reflecting relationships between portions of an image at a first resolution and second data reflecting relationships between the portions of the image at a second resolution, wherein the first resolution is different than the second resolution;
combining the first data and the second data to assign a first area of the image to a first object and a second area of the image to a second object; and
generating a mask for the image based on the first area and the second area.

2. The method of claim 1, wherein combining the first data and the second data includes:
up-sampling a portion of the second data that corresponds to a portion of the first data to the first resolution; and
combining at least some of the relationships in the portion of the second data with the relationships in the portion of the first data.

3. The method of claim 1, wherein areas of the image represented in the first data are assigned to one of a first number of portions and areas of the image represented in the second data are assigned to one of a second number of portions, the first number being a multiple of the second number, and combining the first data and the second data includes:
up-sampling the portions of the image reflected in the second data; and
adding the relationships of the first data and the relationships of the second data.

4. The method of claim 1, wherein the first data is from a first layer of a stable diffusion model and the second data is from a second layer of the stable diffusion model, the first layer and the second layer being received from a single denoising pass of the stable diffusion model on the image.

5. The method of claim 4, wherein a plurality of layers are received from the stable diffusion model, the relationships between portions of the image are represented by respective self-attention maps, and combining the plurality of layers includes:
generating a plurality of aggregated attention maps; and
iteratively merging the plurality of aggregated attention maps to generate a set of objects, the set of objects including the first object and the second object.

6. The method of claim 5, wherein iteratively merging the plurality of aggregated attention maps includes:
determining an anchor portion;
calculating respective pairwise distances between the anchor portion and the plurality of aggregated attention maps; and
merging aggregated attention maps with the anchor portion where the respective pairwise distance is smaller than a divergence threshold.

7. The method of claim 1, wherein assigning the first area to the first object includes:
generating a set of object proposals as probability maps;
identifying, for the first area, an object proposal from the set of object proposals with a top-scoring probability; and
assigning the first area to membership in the object proposal.

8. The method of claim 1, wherein the mask includes a first segment for the first object and a second segment for the second object and the method further comprises processing a portion of the image that corresponds to the first segment.

9. The method of claim 1, wherein the mask includes a first segment for the first object and a second segment for the second object and the method further comprises providing the image and the first segment to a machine-learned model, the machine-learned model analyzing a portion of the image that corresponds to the first segment.

10. A method comprising:
aggregating relationships between portions of an image from different resolutions to generate correspondence maps;
iteratively merging the correspondence maps to assign areas of the image to a respective object; and
generating a mask for the image based on the areas and the respective objects.

11. The method of claim 10, wherein iteratively merging the correspondence maps includes:
identifying anchor portions of the image based on a sampling grid; and
using the anchor portions to determine pairwise similarities between the anchor portions and other portions of the image,
wherein merging is based on the pairwise similarities.

12. The method of claim 10, wherein iteratively merging the correspondence maps includes:
identifying anchor portions of the image based on a sampling grid; and
using the anchor portions to determine pairwise similarities between the anchor portions and other portions of the image,
wherein merging is based on the pairwise similarities.

13. The method of claim 10, wherein aggregating the relationships includes assigning a respective weight to different resolutions, the weight being used in the aggregation of the relationships between the portions.

14. The method of claim 10, wherein the relationships between portions are received from a generative image model and the generative image model is also provided with a prompt having tokens describing the image and the method further comprises:
aggregating relationships between the tokens and the portions of the image from different resolutions to generate respective token correspondence maps for the tokens; and
for a segment in the mask:
identifying a token from the prompt with a top respective token correspondence map, and
labeling the segment with the token.

15. The method of claim 14, further comprising: filtering a token and the respective token correspondence map for the token corresponding to a preposition word, a beginning of sentence token, or an end of sentence token.

16. The method of claim 14, further comprising: merging segments associated with a same label.

17. The method of claim 14, further comprising: merging segments associated with tokens in a noun phrase.

18. A system comprising:
at least one processor; and
memory storing instructions that, when executed by the at least one processor, causes the system to perform operations including:
receiving first data reflecting relationships between portions of an image at a first resolution and second data reflecting relationships between the portions of the image at a second resolution, wherein the first resolution is different than the second resolution;
combining the first data and the second data to assign a first area of the image to a first object and a second area of the image to a second object; and
generating a mask for the image based on the first area and the second area.

19. The system of claim 18, wherein combining the first data and the second data includes:
up-sampling a portion of the second data that corresponds to a portion of the first data to the first resolution; and
combining at least some of the relationships in the portion of the second data with the relationships in the portion of the first data.

20. The system of claim 18, wherein assigning the first area to the first object includes:
generating a set of object proposals as probability maps;
identifying, for the first area, an object proposal from the set of object proposals with a top-scoring probability; and
assigning the first area to membership in the object proposal.

21. The system of claim 18, wherein the mask includes a first segment for the first object and a second segment for the second object and the operations further include processing a portion of the image that corresponds to the first segment.

22. The system of claim 18, wherein the mask includes a first segment for the first object and a second segment for the second object and the operations further include providing the image and the first segment to a machine-learned model, the machine-learned model analyzing a portion of the image that corresponds to the first segment.

23. A non-transitory computer-readable medium storing instructions that, when executed by at least one processor, causes a computing device to perform operations comprising:
receiving first data reflecting relationships between portions of an image at a first resolution and second data reflecting relationships between the portions of the image at a second resolution, wherein the first resolution is different than the second resolution;
combining the first data and the second data to assign a first area of the image to a first object and a second area of the image to a second object; and
generating a mask for the image based on the first area and the second area.

24. The non-transitory computer-readable medium of claim 23, wherein combining the first data and the second data includes:
up-sampling a portion of the second data that corresponds to a portion of the first data to the first resolution; and
combining at least some of the relationships in the portion of the second data with the relationships in the portion of the first data.

25. The non-transitory computer-readable medium of claim 23, wherein assigning the first area to the first object includes:
generating a set of object proposals as probability maps;
identifying, for the first area, an object proposal from the set of object proposals with a top-scoring probability; and
assigning the first area to membership in the object proposal.

26. The non-transitory computer-readable medium of claim 23, wherein the mask includes a first segment for the first object and a second segment for the second object and the operations further include processing a portion of the image that corresponds to the first segment.

27. The non-transitory computer-readable medium of claim 23, wherein the mask includes a first segment for the first object and a second segment for the second object and the operations further include providing the image and the first segment to a machine-learned model, the machine-learned model analyzing a portion of the image that corresponds to the first segment.
